(19) United States
(12) Patent Application Publication
(10) Pub. No.: US 2003/0037332 A1
(43) Pub. Date: Feb. 20, 2003

(54) System and method for storyboard interactive television advertisements

(76) Inventors: Paul W. Chapin, Edina, MN (US); Scott J. Sample, Blaine, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/960,231

(22) Filed: Sep. 20, 2001

Related U.S. Application Data
(60) Provisional application No. 60/234,070, filed on Sep. 20, 2000.

(51) Int. Cl. H04N 7/025; H04N 7/10; G06F 3/00; H04N 5/445; G06F 13/00

(52) U.S. Cl. 725/35; 725/36; 725/42

(57) ABSTRACT

The present invention relates to a storyboard model for interactive video advertisement packages. An initial real time, predetermined video advertisement segment is delivered package is delivered over a broadcast interactive television medium in a conventional advertising spot time frame. The initial video advertisement segment includes a dynamic sequence presenting a storyboard model representation having a plurality of selectable zones. Each zone is defined in relation to a unique part of the storyboard model representation and has a corresponding selectable, predetermined video advertisement segment associated with that zone. One of the selectable video advertisement segments corresponding to a viewer selected zone is delivered to the viewer in direct response to selection by the viewer of that zone that present parts of a storyline.

### RELATED APPLICATIONS

This application claims the benefit of U.S. Provisional Patent Application No. 60/234,070, filed Sep. 20, 2000, incorporated herein in its entirety by reference.

### COMPACT DISC

A compact disc containing codes and information describing a preferred embodiment of the present invention is submitted herewith and is hereby incorporated by reference. The compact disc contains the following files and/or programs:

| Title | Size in Bytes | Date of Creation |
|---|---|---|
| bremer.8.16.00.dcr | 948K | Aug. 16, 2000 |
| bud.8.16.00.dcr | 1.3 MB | Aug. 16, 2000 |
| cool_boots.8.13.00.dcr | 1.5 MB | Aug. 25, 2000 |
| corporate.8.1.6.00.dcr | 624K | Aug. 25, 2000 |
| rwa.8.14.00.dcr | 540K | Aug. 17, 2000 |

### FIELD OF THE INVENTION

This invention relates to interactive video distribution processes, systems, and elements thereof characterized by point-to-multipoint system configurations, and which are used for the unidirectional distribution or delivery of motion video data resulting from interactions between users and systems elements. In particular, this invention relates to interactive advertisement or commercial information displays that offer viewers an opportunity to selectively interrupt real time advertisements to display alternative advertisements in their place.

### BACKGROUND OF THE INVENTION

During the past two to three decades, the public has had the opportunity to observe significant developments in two important communications medium, television and the Internet. Developments in television include, for example, high resolution color television, home video machines, cable, and satellite broadcasting, digital television, and interactive television. Developments in the Internet have focused on increasing “last mile” bandwidth by designing, for example, faster routers and on decreasing server response time by moving content closer to the edge of the network through the use of Web caching and content replication.

Although television—herein used to refer to all forms of real time audio-video broadcast networks such as conventional television, cable, and satellite—and the Internet are viewable on similar video display devices, the differences between these two mediums remain profound. There are several reasons for this. First, the Internet remains a two-way medium carrying largely static content for point-to-point distribution, while television in general is a real time, dedicated one-way medium with dynamic content for point-to-multipoint distribution or broadcasting. Second, distributing a Web page from a computer browser output directly onto a television display is not a very satisfying experience, because of what is often referred to as the “twelve inch versus twelve foot experience”. Internet content is usually viewed by a single user sitting close to a computer display, and Web page fonts and graphics are generally too small to be comfortably viewed on a television display without specially transcoding the content. Television content is usually viewed from greater distances and often by a group of viewers, and broadcast networks are designed to transmit rich, multimedia content by delivering a high-quality, synchronized audio and video signal to a large viewer population. Third, the Internet is a “best-efforts” network. Data moves through networks in a hop-by-hop, asynchronous manner and some data packets can be dropped arbitrarily or delayed. These errors introduce a degree of unpredictability and unreliability in content delivery in addition to server response time problems. Broadcast networks provide predictable performance; because of their synchronized point-to-multipoint transmission, there are no variances in the propagation delay of data throughout a network's transmission footprint. Finally, the Internet is not readily scalable in terms of point-to-multipoint transmissions. As a point-to-point network, when data needs to be sent to several locations, additional copies of the same data are sent separately. In contrast, broadcast networks are inherently scalable because of their point-to-multipoint transmission capability. Because of all these differences, concepts and techniques for allowing individual interaction with Internet context are generally not transferable to the medium of television, even the advancements with respect to interactive television.

Interactive television is television enhanced with the attributes of personalization and responsiveness by designing choice into the medium such as has the Internet. The term “interactive television” thus can generally be defined as anything that allows a viewer to selectively engage a television broadcast system to access new and/or advanced presentations other than by channel selection. Unlike the Internet, however, interactive television has dedicated, real time continuous broadcasting unless a viewer chooses to interrupt the real time content by selectively requesting an alternative presentation.

Examples of Internet/computer experiences are Doyle, U.S. Pat. No. 4,847,604, Method and Apparatus for Identifying Features of an Image on a Video Display, and Makkuni et al., U.S. Pat. No. 5,010,500, Gesture-Modified Diagram for Retrieval of Image Resembling Diagram, with Parts Selectable for Further Interactive Retrieval. Doyle teaches about a computer display graphic interface that allows a user to obtain descriptive information concerning a feature of a displayed image by pointing to the location of the feature. Makkuni et al. teaches about selecting a part of a still image in a workstation environment to display a menu that includes a description of video segments related to that part. Because both of these inventions are twelve inch experiences, they are not readily adaptable to the interactive television medium.

Examples of a twelve foot interactive television experience can be found in Hayashi, U.S. Pat. No. 5,995,134, Method and Apparatus for Enticing a Passive Television Viewer by Automatically Playing Promotional Presentations of Selectable Options in Response to the Viewer's Inactivity; Hooks et al., U.S. Pat. No. 6,169,542 B1, Method of Delivering Advertising Through an Interactive Video Distribution System; and Clanton, III et al., U.S. Pat. No. 5,745,710, Graphical User Interface for Selection of Audiovisual Programming. Hayashi teaches about a system for displaying a menu of promotional presentation options wherein the system defaults to presenting one of the presentations if the viewer fails to select an option within a given amount of time. Hooks et al. teaches about a menu of selectable options built up from advertisements for which a registration request was received by a viewer. In each of these patents, then, it is necessary for a viewer to select an option, or to wait for a default selection from among the selectable options to begin, before the system will continue in real time. Clanton, III et al. teaches about an interface for displaying and selecting video-on-demand programs as well as other programs and interactive services. Clanton, III et al. discloses a movie studio back lot metaphor having a poster wall that presents a series of movie posters representing available movie selections. Selecting an icon in the form of a poster transforms the icon into information about a movie or movie advertisement. Like Hayashi and Hooks et al., the invention in Clanton III, et al. does not continue in real time unless and until the viewer selects an icon.

Kitsukawa et al., U.S. Pat. No. 6,282,713 B1, Method and Apparatus for Providing On-Demand Electronic Advertising, is also an example of the twelve foot interactive television experience. Kitsukawa et al. teach about a video broadcast network related invention wherein on-demand advertisements are provided for items and services used in scenes of television programming. Selected advertisement modes alert a viewer when advertising information is available as a selectable option within the context of the broadcast programming. The alert comprises a tone and indicator marks that are superimposed over broadcasted programming. An advertisement for a particular item is requested by a viewer by selecting the indicator marks corresponding to the item in which the viewer is interested. The advertisement is then displayed along with the broadcast of the current television programming by superimposing the advertisement over the broadcast of the television programming or on a portion of the display along with the television programming, either of which may be displayed in a picture-in-picture inset. This mode of advertising has several disadvantages. From a viewer's perspective, an advertisement cannot be viewed in advertising mode unless a viewer does so in cyber time, thus forcing the viewer to break his or her focus away from real time programming. From an advertiser's perspective, the viewer is not exposed to advertisements unless the viewer selects an advertising mode, and a product or service cannot be advertised independently from the television programming. To make use of this invention, it is necessary to abandon the existing models of advertising whereby discrete broadcast time slots are sold to promoters and advertisers.

Although numerous attempts have been made to provide more interactive advertisement opportunities, existing techniques are either not suitable for the interactive television medium, because they rely on the assumptions inherent in the twelve inch experience of the Internet, or because they require user interaction or time delay before continuing. The undesirable results of this latter reason are especially noticeable in those situations where not all viewers have interactive capabilities. Accordingly, it would be desirable to provide an advertisement delivery system that is particularly adapted to the interactive television medium and that can take advantage of the benefits associated with interactive advertisements.

### SUMMARY OF THE INVENTION

The present invention introduces a new paradigm in interactive advertising, the storyboard model. Interactive advertising is commercial advertising that allows immediate, real time, two-way interactivity between a viewer and an advertiser. For advertisers, interactive television provides much greater efficiency in media buys, better viewer targeting, and an ability to go from brand message to product delivery almost instantaneously. It gives advertisers new choices in delivering content to their audience and subsequently gaining valuable insights into their consumers in the form of marketing data that can be obtained because of consumer interaction with advertising content.

The present invention relates to a storyboard model for interactive video advertisement packages. An initial real time, predetermined video advertisement segment is delivered over a broadcast interactive television medium in a conventional advertising time frame or spot. The initial video advertisement segment includes a dynamic sequence presenting a storyboard model representation having a plurality of selectable zones. Each zone of the storyboard model representation corresponds to selectable, predetermined video advertisement segment associated with that zone. The selectable video advertisement segments corresponding to a viewer selected zone is delivered to the viewer in direct response to selection by the viewer of that zone and presents one part of a storyline.

This invention is a significant development with respect to how advertisers may be charged for advertisements in an interactive television medium. In traditional advertising, advertising time is purchased based on time slots (e.g., 15, 30, 60 second spots). Existing models of interactive television advertising generally have adopted the click-through pricing models common to the Internet by charging advertisers based on the number of times viewers interact with the advertisement.

In the new model provided by the present invention, advertisements can be sold both as spot advertisements for the initial advertisement segment and as the interactive television equivalent of click-through charges when a viewer having interactive capability selects one of the selectable advertising segments. The business model is particularly advantageous in environments in which a portion of the viewing population is not equipped with television sets having interactive capability. For those viewers, advertisers can still create effective advertisements that fit into the conventional pricing model of how existing television ads are bought and sold. For viewers having interactive capability, a further pricing model can be applied to charge on a per view/per selection basis for the increased user interactive with an selectable advertisement segment.

Interactive advertising can run in either real time or cyber time. Real time programming is programming the way the viewer has traditionally viewed television. The time frame of the programming is continuous during broadcasting and never interrupted. It may or may not be selectable, an example of the former being video-on-demand. Cyber time programming is programming that is both selectable and can be interrupted. Selectable zones are used to move between selections in real time, between real time and cyber time, or between two selections occurring in cyber time. The term “selectable zone” refers to an area on a video display which, if selected by any mechanism such as a mouse, joystick, IR remote control, or keyboard, causes some computer process to happen, such as reconfiguring the display. It will be understood that any number of hardware and software platforms of the broadcast interactive television medium can be utilized to implement the storyboard model in accordance with the present invention. Moreover, advertising packages and the advertising segments that make up these packages can be stored at, and called from the viewer's set-top box or from a broadcast server.

This model is designed to work either in or out of real time. If the viewer chooses not to interact, real time programming continues at the end of the advertisement's time slot and the viewer never leaves real time. At any point in the advertisement that the viewer makes a selection, the viewer most likely will begin viewing in cyber time, depending on the advertising package and the circumstances.

### BRIEF DESCRIPTION OF THE DRAWINGS

FIGS. 1-4 illustrates an interactive video advertisement package displaying an advertisement segment from an advertising campaign having multiple advertisements in a storyline.

FIG. 5 is a schematic diagram of one embodiment of an interactive television environment.

### DETAILED DESCRIPTION OF THE PREFERRED EMBODIMENTS

One embodiment of the present invention allows a viewer to select a campaign of advertising segments having a common theme and to then select a particular advertising segment from the ad campaign or series. The embodiment also allows the viewer to successively view advertising segments from the same or multiple, alternative ad campaigns. The concept behind this paradigm is to allow the viewer to select an alternative advertisement segment to that which is being shown in real time, to select an advertisement segment from a different ad campaign altogether, or any combination of these. By doing so, interactive video advertisement packages invite the viewer to spend significantly more time with an advertiser's messages and provide ways to access additional information.

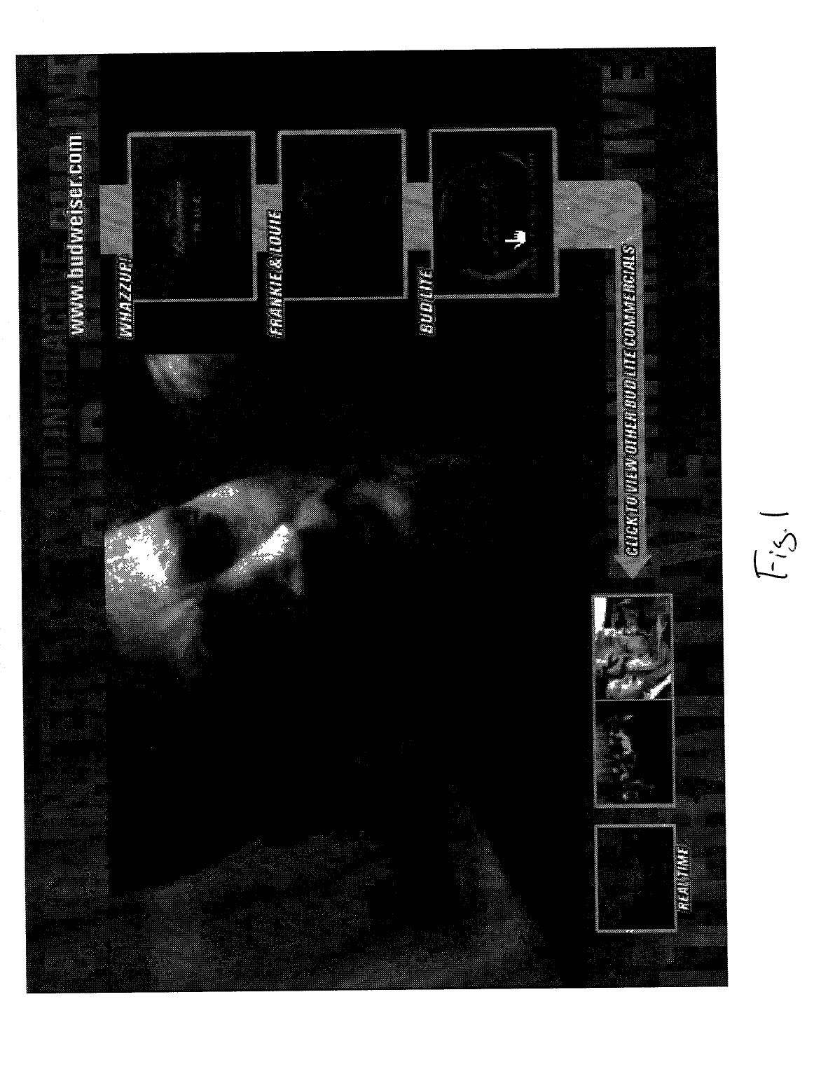

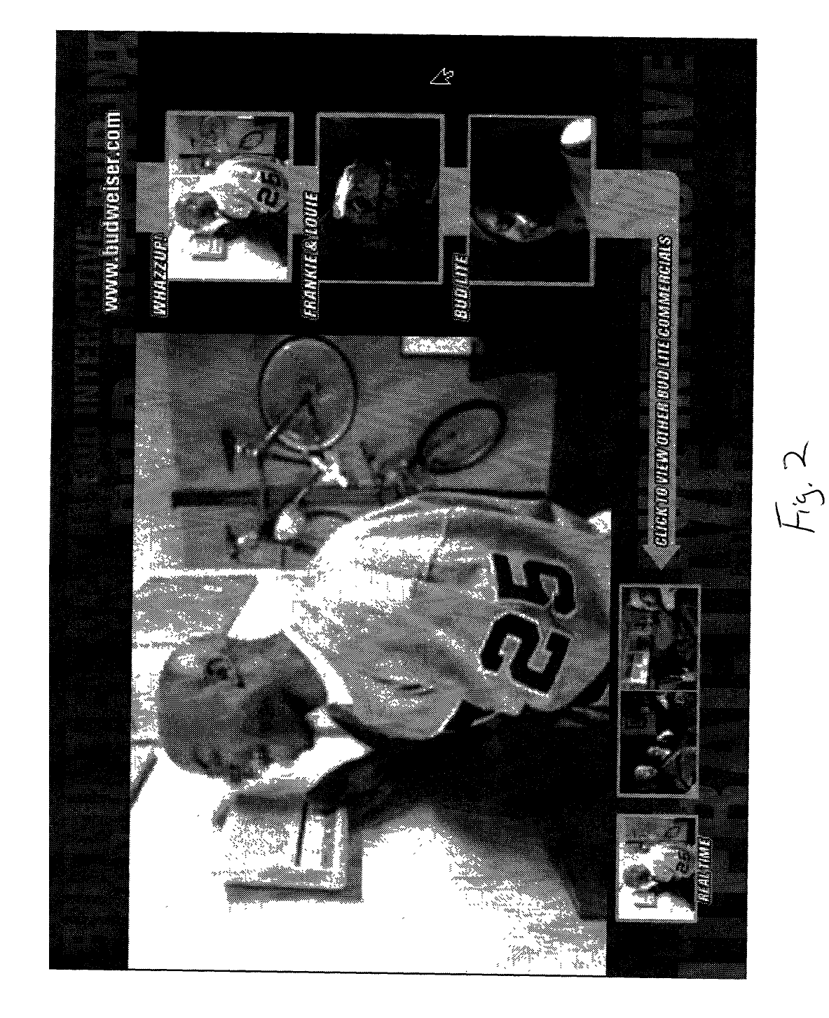

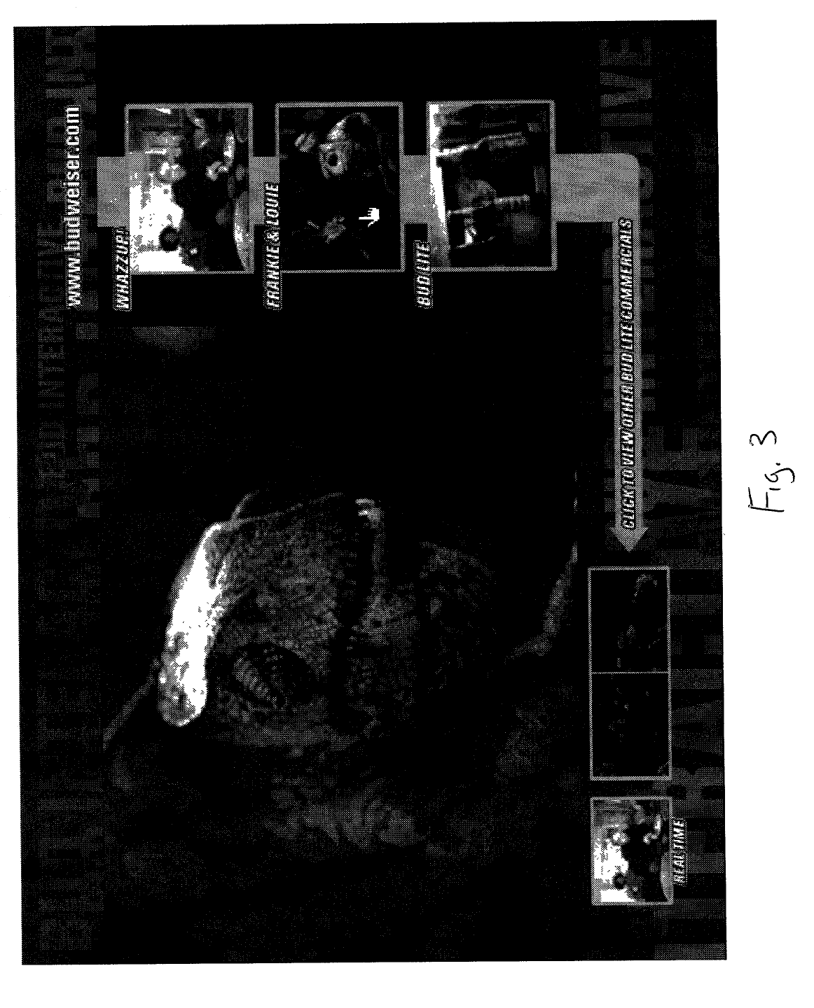

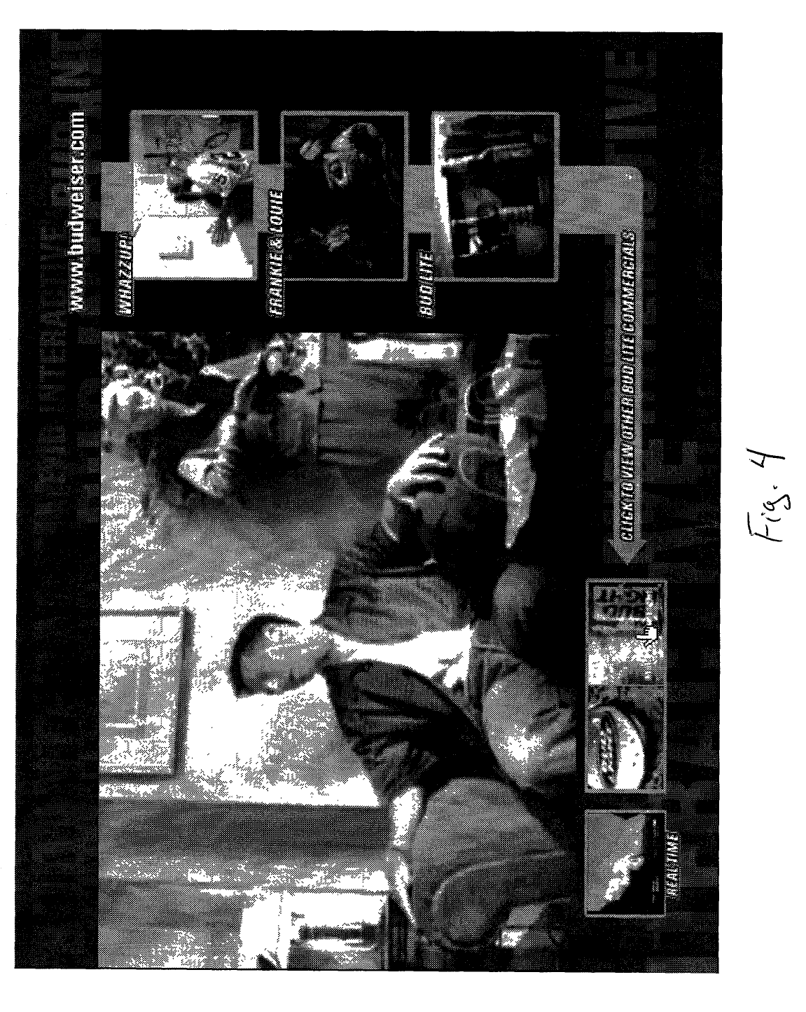

For example as shown in FIGS. 1-4, a national beverage company may create several storylines for its beverages that are humorous, entertaining, and key to solidifying brand loyalty. The embodiment provides the beverage company a venue for allowing a viewer of its advertisements to select which of the beverage company's advertisements the viewer wants to enjoy. The embodiment begins with the interactive “i” logo and an initial real time, predetermined video advertisement segment. The segment displays four small picture-in-picture windows in addition to the main or dominant display area. A smaller or larger number of windows can be displayed as is appropriate. Each of the windows is a selectable zone and displays a representation (either still or video) of only the visual part (i.e., no audio) of an advertisement segment from another, different ad campaign. In the dominant display area, an advertisement segment from an ad campaign is presented in real time. If the viewer merely watches the advertisement segment in the dominant area, the spot representing the initial advertisement segment will play out and real time programming will continue. If the viewer selects one of the selectable zones, the viewer enters cyber time and can view the selected advertisement from the selected ad campaign. The advertisement that was playing in the selected selectable zone becomes the presentation in the dominant display area. The visual part of the presentation that is replaced is displayed in a picture-in-picture window that also is a selectable zone. In addition to other picture-in-picture windows, preferably each of the advertisement segments of the storyline of the selected ad campaign appears in a picture-in-picture window at the bottom of the dominant display area and is a selectable zone. It is these windows that create a storyboard. Any previously displayed storyboard disappears. The viewer then has a full compliment of selections between ad campaigns, including that being presented in real time, and between individual advertisement segments that comprise the selected ad campaign. The viewer may stay in an advertisement segment as long as the viewer desires or jump between advertisement segments and ad campaigns randomly. Preferably, a real time broadcast window is always present on the display to let the viewer know what is currently being broadcast in real time. If the viewer wants to resume viewing the current broadcast at any time, the viewer need only select the real time broadcast window to do so.

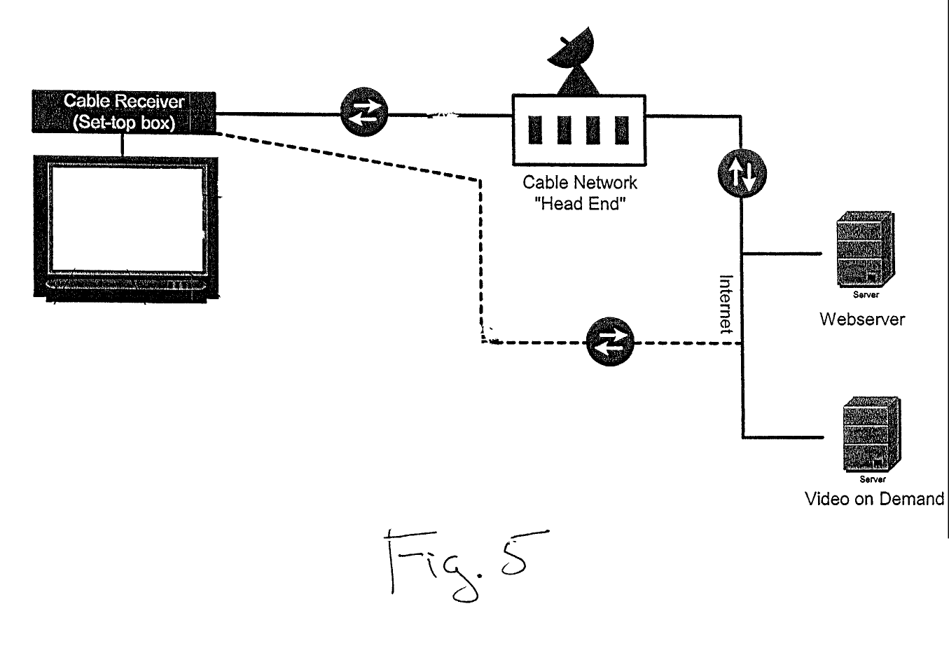

The preferred technology for implementing the present invention utilizes known picture-in-picture technology delivered over any number of known embodiments of interactive telvision broadcast mediums, such as shown for example in FIG. 5. A variety of predetermined video advertisement segments are streamed into predefined picture-in-picture windows. An invisible overlay over the entire screen allows each window to be a selectable zone without interrupting the video being streamed inside of it. Depending on the content of a window, selecting the window sends specific instructions to a computer (set top box) to reconfigure the screen for the viewer. A small window may become a large window and vice versa, and more windows may pop up allowing for more selections. A real time broadcast window included in the development of the advertisement package allows the viewer to return to the traditional broadcast signal from an alternative selection. Additionally, buttons could be included in a display that would allow the viewer to jump to an advertiser's Web site served by their traditional ISP. In this case, technology that employs a real time broadcast window while the Web site is being served is necessary to allow the user to return to the traditional broadcast signal. Preferably, the real time broadcast window can shrink and grow as video is continuously and dynamically streamed into the window in real time.

An alternative and simpler embodiment demonstrates another way for a viewer to select an advertisement segment. Windows for various products or services are implemented whether or not they are related by a storyline. Corresponding advertisement segments may relate to the same product or service, different products or services of the same company, or different products or services of different companies as promoters coop a broadcast time.

A detailed description of a preferred embodiment of scripting the presentation and operation of the initial advertisement video segment and the plurality of selectable advertisement video segments is presented in the source code which is on the compact disc submitted herewith and incorporated by reference herein.

Although the preferred embodiment of the storyboard model for an interactive video advertisement package of the present invention has been described herein, it will be recognized that numerous changes and variations can be made and that the scope of the present invention is to be defined by the claims.

What is claimed:

1. An interactive video advertisement package for delivery over a broadcast interactive television medium comprising:
an initial real time, predetermined video advertisement segment deliverable over the broadcast interactive television medium, the initial video advertisement segment having a plurality of selectable zones; and
a plurality of selectable, predetermined video advertisement segments, each selectable video advertisement segment corresponding to one of the plurality of selectable zones and selectively delivered to a viewer in direct response to selection by the viewer of that zone, and wherein at least one of the selectable zones corresponds to a plurality of selectable, predetermined video advertisement segments that present parts of a storyline.

2. The interactive video advertisement package of claim 1, wherein each selectable zone and corresponding advertisement segment correspond to the same product or service.

3. The interactive video advertisement package of claim 1, wherein each selectable zone and corresponding advertisement segment correspond to a different product or service.

4. The interactive video advertisement package of claim 1, wherein each selectable zone and corresponding advertisement segment corresponds to a promotion by a different company.

5. The interactive video advertisement package of claim 1, wherein unselected selectable zones are rep resented by a picture-in-picture windows.

6. The interactive video advertisement package of claim 1, wherein a real time picture-in-picture window selectable zone appears displaying real time video programming while the viewer is viewing an advertisement segment in cyber time, and wherein the viewer is returned to real time programming in direct response to selecting the real time selectable zone.

7. An interactive video advertisement package for delivery over a broadcast interactive television medium comprising:
an initial real time, predetermined video advertisement segment deliverable over the broadcast interactive television medium, the initial video advertisement segment having a plurality of selectable zones; and
a plurality of selectable, predetermined video advertisement segments, each selectable video advertisement segment corresponding to one of the plurality of selectable zones and selectively delivered to a viewer in direct response to selection by the viewer of that zone.

8. A method of presenting an interactive video advertisement package over a broadcast interactive television medium comprising:
simultaneously delivering an initial real time, predetermined video advertisement segment to a plurality of viewers over the broadcast interactive television medium, the initial video advertisement segment having a plurality of selectable zones;
providing a plurality of selectable, predetermined video advertisement segments, each selectable video advertisement segment corresponding to one of the plurality of selectable zones, and wherein at least one of the selectable zones corresponds to a plurality of selectable, predetermined video advertisement segments that present parts of a storyline; and
in response to selection of a selectable zone by one of the plurality of viewers, directly delivering the corresponding selectable video advertisement segment to that viewer.
